(19) United States
(12) Patent Application Publication
(10) Pub. No.: US 2013/0151465 A1
(43) Pub. Date: Jun. 13, 2013

(54) RANGE AND PATTERN SELECTION IN REPORTING SOLUTIONS RELATED TO ANALYTICAL MODELS

(71) Applicant: Dirk Baumgaertel, Hockenheim (DE)

(72) Inventor: Dirk Baumgaertel, Hockenheim (DE)

(21) Appl. No.: 13/314,200

(22) Filed: Dec. 8, 2011

(51) Int. Cl. G06F 17/00

(52) U.S. Cl. 707/600; 707/E17.005

(57) ABSTRACT

Various embodiments of systems and methods for range and pattern selection in reporting solutions related to analytical models are described herein. Selection of range of values or pattern selection is performed and then the values are transformed to a list of single variables known to the underlying online analytical processing system.

### FIELD

The invention relates to Online Analytical Processing (OLAP) analysis. More precisely, the field relates to order based selection on non-ordered values in reporting solutions.

### BACKGROUND

Within many business programming applications, the business object data model is mainly based on Universally Unique Identifier (UUID). The UUIDs are used as keys to Business Object (BO) instances or to model references between BO instances. The approach using UUIDs has its advantages within the BO model, because it is simple to identify a BO instance, but from an end user perspective it is inconvenient since the user cannot deal with technical identifiers (IDs) such as the UUIDs. Typically, a user deals with human readable IDs, which are then converted to UUIDs. A system normally allows a user to enter a human readable ID. The UUID and the human readable ID normally have a one-to-one relationship. This relationship allows replacement of the technical UUID on the user interface (UI) by the human readable ID. The human readable ID is considered external representation of the value, while the UUID is the internal representation of the value. The values, which the user enters in the external representation (the human readable IDs) are only converted to the internal representation of the values (the UUIDs), but the cardinality is not changed.

The model of the Multidimensional Views (MDAV) is closely linked to the model of the BO. Hence, the same situation is met in the analytical model. The transactional MDAV, like the MDAV for the BO Purchase Order for example, contains only the UUID keys and no human readable IDs. Although this concept allows solving the problem, that a user does not have to deal with the UUIDs, which are technical IDs, a problem arises if the underlying OLAP system supports selection of single values only. This means a user can select, for example, a business partner with a human readable ID BP2000, but the user cannot select all the business partners within the range BP2000 to BP4000. It is also not possible to select a pattern like “BP*” to include all the IDs starting with “BP”. The same applies for the operators less than (<) or greater than (>). The reason for this limitation is that the internal values (the UUIDs) of the human readable IDs are not necessarily ordered. This means it is insufficient to convert the external values BP2000 and BP4000 into their internal values and to select all instances between these two values.

### SUMMARY

Various embodiments of systems and methods for range and pattern selection in reporting solutions related to analytical models are described herein. In one embodiment, the method includes receiving a user entry of one or more identifiers (IDs) as a range of ordered values for querying data and generation of analytical result, the one or more IDs being external representation of one or more universally unique identifiers (UUIDs) and analyzing the one or more IDs to extract a list of non-ordered UUIDs, the list of non-ordered UUIDs being internal representation of the one or more IDs. The method also includes passing the extracted list of non-ordered UUIDs to an Online Analytical Processing (OLAP) processor and selecting, through the OLAP processor, data using the list of non-ordered UUIDs for the generation of the analytical result.

In other embodiments, the system includes at least one processor for executing program code and memory. The system also includes a user interface to receive a user entry of one or more identifiers (IDs) as a range of ordered values for querying data and generation of analytical result, the one or more IDs being external representation of one or more universally unique identifiers (UUIDs). The system further includes a parameter handling module to analyze the one or more IDs and to extract a list of non-ordered UUIDs, the list of non-ordered UUIDs being internal representation of the one or more IDs and an OLAP processor to select data using the list of non-ordered UUIDs for the generation of the analytical result.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram representing an embodiment of a system for range and pattern selection in reporting solutions related to analytical models.

FIG. 2 is a flow diagram of an embodiment of a method for range and pattern selection in reporting solutions related to analytical models.

FIG. 3 is a block diagram of an embodiment of a system for range and pattern selection in reporting solutions related to analytical models.

FIG. 4 is a block diagram illustrating a computing environment in which the techniques described for range and pattern selection in reporting solutions related to analytical models can be implemented, according to an embodiment of the invention.

### DETAILED DESCRIPTION

Embodiments of techniques for range and pattern selection in reporting solutions related to analytical models are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

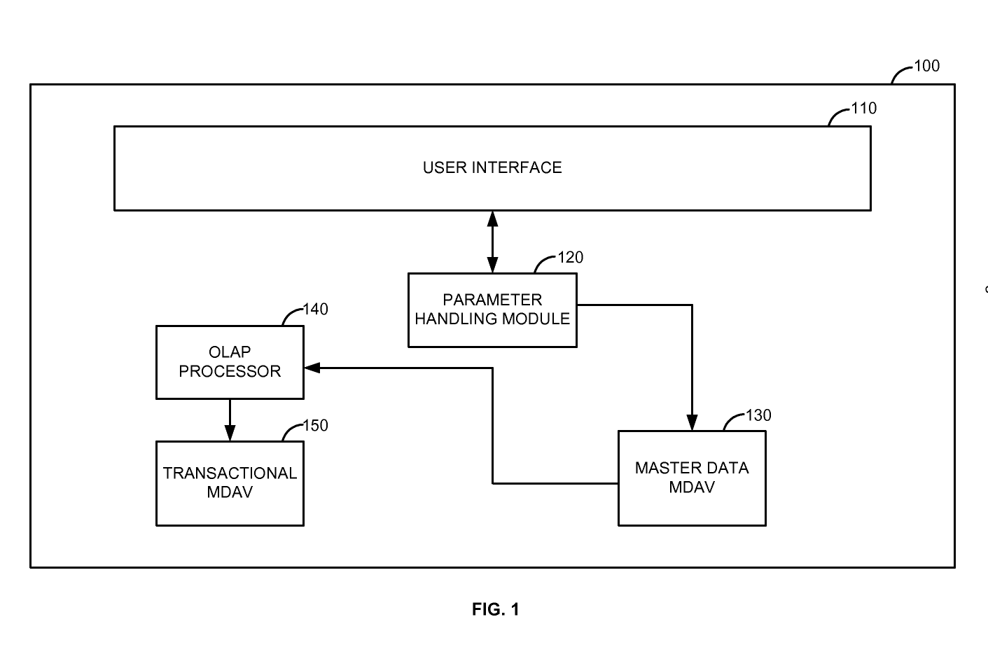

FIG. 1 represents a block diagram of an embodiment of a system 100 for range and pattern selection in reporting solutions related to analytical models. The system 100 includes a user interface 110. A user selection for querying data is performed by means of the user interface 110. In one embodiment, a user entry includes human readable identifiers (IDs). The IDs may be such as the IDs presented on the right side of Table 1:

TABLE 1

| UUID | ID |
|---|---|
| UUID-1 | 10 |
| UUID-2 | 20 |
| UUID-3 | 30 |
| UUID-4 | 15 |
| UUID-5 | 18 |

The human readable IDs correspond to universally unique identifiers (UUIDs). The UUIDs are intrinsic to the BO model and they are technical IDs. The human readable IDs are an external representation of the UUIDs. A parameter handling module 120 analyses the IDs received by means of the user interface 110 and extracts the corresponding UUIDs from the master data MDAV 130. The master data MDAV 130 provides ID-UUID mapping. A pre-query on the maintained master data MDAV returns a complete list of values in the internal representation (UUIDs), which match the selection in the external representation (IDs). An example of master data MDAV content is presented in Table 1. Then a list of UUIDs is sent to an OLAP processor 140 to query data from a transactional MDAV 150. Typically, the transactional MDAV 150 uses UUIDs only and no other IDs. An example of transactional MDAV is presented in Table 2:

TABLE 2

| UUID | Amount | Date |
|---|---|---|
| UUID-1 | 100.00 [symbol] | Oct. 20, 2011 |
| UUID-2 | 200.00 [symbol] | Oct. 20, 2011 |
| UUID-3 | 150.00 [symbol] | Oct. 20, 2011 |
| UUID-4 | 120.00 [symbol] | Oct. 21, 2011 |
| UUID-5 | 140.00 [symbol] | Oct. 22, 2011 |
| UUID-3 | 170.00 [symbol] | Oct. 23, 2011 |
| UUID-4 | 190.00 [symbol] | Oct. 22, 2011 |
| UUID-5 | 200.00 [symbol] | Oct. 24, 2011 |
| UUID-1 | 210.00 [symbol] | Oct. 24, 2011 |
| UUID-2 | 110.00 [symbol] | Oct. 22, 2011 |
| UUID-4 | 210.00 [symbol] | Oct. 23, 2011 |
| UUID-5 | 130.00 [symbol] | Oct. 19, 2011 |
| UUID-4 | 100.00 [symbol] | Oct. 21, 2011 |

In one embodiment, the user entry includes a range of human readable IDs. In this embodiment, the list of UUIDs includes the corresponding UUIDs of the whole range of human readable IDs.

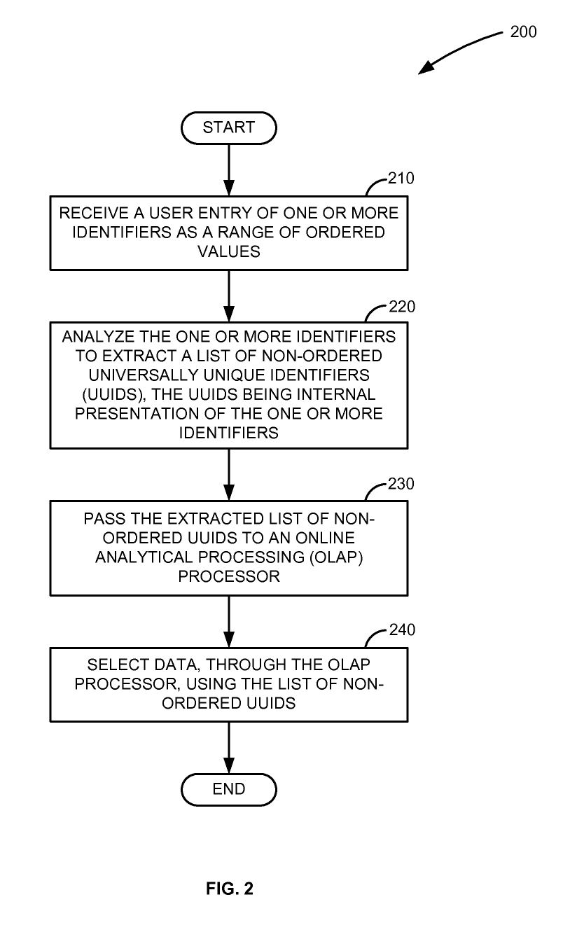

FIG. 2 is a flow diagram of an embodiment of a method 200 for range and pattern selection in reporting solutions related to analytical models. The method begins at block 210 with receiving a user entry of one or identifiers (IDs) as a range of ordered values. The user entry serves for querying data and generation of analytical result. In one embodiment, the IDs are human readable IDs. Human readable IDs, as opposed to technical IDs, are identifiers directed to the queried data. The technical IDs are directed to the type of data, for example the type of the BO containing the queried data. Then, at block 220, the one or more IDs are analyzed to extract a list of non-ordered universally unique identifiers (UUIDs). The UUIDs are internal representations of the one or more IDs. In one embodiment, the UUIDs are used as keys of BO instances. In one embodiment, the UUIDs are used to model references between business model instances. In yet another embodiment, analyzing the one or more IDs to extract the list of non-ordered UUIDs is performed by querying a master data Multidimensional View (MDAV). The master data MDAV maintains ID-UUID mapping. In one embodiment, the extracted list of non-ordered UUIDs matching the user entry of IDs is received by pre-querying the master data MDAV. Further, at block 230, the extracted list of non-ordered UUIDs is passed to an OLAP processor. The OLAP processor works with UUIDs, but not the user entry with IDs as a range of ordered values. Then, at block 240, data is selected, through the OLAP processor, using the list of non-ordered UUIDs. In one embodiment, the data selected, through the OLAP processor, using the list of non-ordered UUIDs, is selected from a transactional MDAV.

A use case for range selection is, for example, selecting IDs within the range 20 . . . 30. If the master data MDAV is as the one presented in Table 1, and the transactional MDAV is the one presented in Table 2, the analyzed UUIDs corresponding to the ID range 20 . . . 30 are UUID-2 and UUID-3. Thus, the extracted list of UUIDs includes UUID-2 and UUID-3. Then, the selected data from the transactional MDAV using the list of UUIDs will be the data presented in Table 3:

TABLE 3

| UUID | Amount | Date |
|---|---|---|
| UUID-2 | 200.00 [symbol] | Oct. 20, 2011 |
| UUID-3 | 150.00 [symbol] | Oct. 20, 2011 |
| UUID-3 | 170.00 [symbol] | Oct. 23, 2011 |
| UUID-2 | 110.00 [symbol] | Oct. 22, 2011 |

As can be seen from the above stated example, all the data corresponding to the UUID-2 and UUID-3 is selected.

A use case for pattern selection is, for example, selecting IDs within the pattern “1*” (starting with 1). If the master data MDAV is as the one presented in Table 1, and the transactional MDAV is the one presented in Table 2, the analyzed UUIDs corresponding to the ID pattern “1*” are UUID-1, UUID-4, and UUID-5. Hence the extracted list of UUIDs includes UUID-1, UUID-4, and UUID-5. The selected data from the transactional MDAV in this case is presented in Table 4:

TABLE 4

| UUID | Amount | Date |
|---|---|---|
| UUID-1 | 100.00 [symbol] | Oct. 20, 2011 |
| UUID-4 | 120.00 [symbol] | Oct. 21, 2011 |
| UUID-5 | 140.00 [symbol] | Oct. 22, 2011 |
| UUID-4 | 190.00 [symbol] | Oct. 22, 2011 |
| UUID-5 | 200.00 [symbol] | Oct. 24, 2011 |
| UUID-1 | 210.00 [symbol] | Oct. 24, 2011 |
| UUID-5 | 130.00 [symbol] | Oct. 23, 2011 |
| UUID-4 | 100.00 [symbol] | Oct. 19, 2011 |

Turning back to FIG. 2, in one embodiment, the data selected through the OLAP processor at block 240 is filtered using a predefined filter. For example, the queried data is filtered by a time filter, thus excluding the values outside a predefined time period. So in the case of pattern selection, presented above, if the filter restricts the data to Oct. 24, 2011, then the selected data from the transactional MDAV will be reduced to the data presented in Table 5:

TABLE 5

| UUID | Amount | Date |
|---|---|---|
| UUID-5 | 200.00 [symbol] | Oct. 24, 2011 |
| UUID-1 | 210.00 [symbol] | Oct. 24, 2011 |

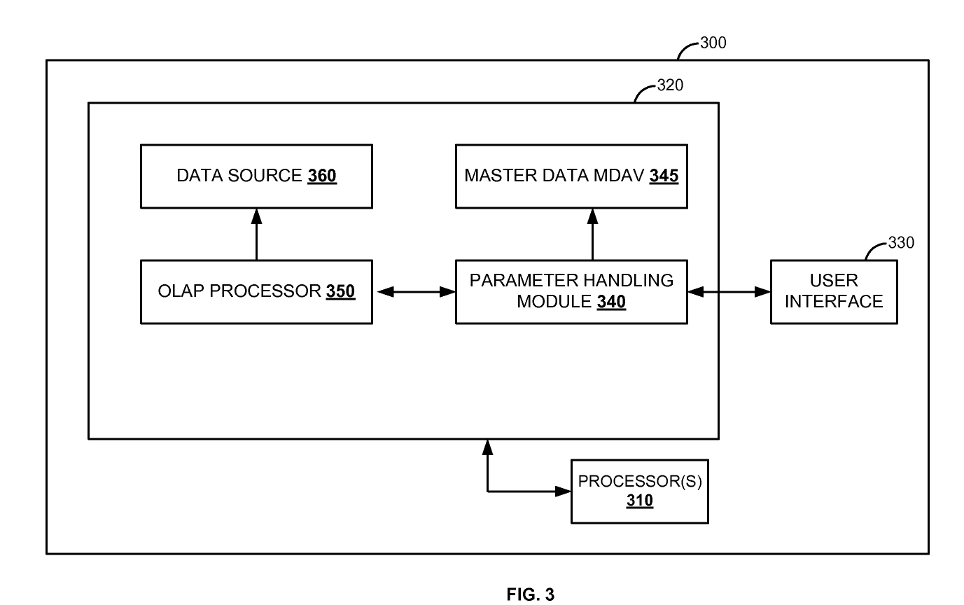

FIG. 3 is a block diagram of an embodiment of a system 300 for range and pattern selection in reporting solutions related to analytical models. The system includes one or more processors 310 for executing program code. Computer memory 320 is in connection to the one or more processors 310. The system 300 further includes a user interface 330 for receiving a user entry of one or more identifiers (IDs) as a range of ordered values for querying data and generation of analytical result, the one or more IDs being external representation of one or more universally unique identifiers (UUIDs). In one embodiment, the IDs are human readable IDs. In another embodiment, the UUIDs are used as keys of business object instances. In yet another embodiment, the UUIDs are used to model references between business model instances.

The memory 320 also includes a parameter handling module 340 and an OLAP processor 350. The parameter handling module 340 is intended to analyze the one or more IDs and to extract a list of non-ordered UUIDs, the list of non-ordered UUIDs being internal representation of the one or more IDs. In one embodiment, the parameter handling module is further operable to pre-query a master data Multidimensional View (MDAV) 345, the master data MDAV 345 maintaining ID-UUID mapping. The OLAP processor 350 is in communication with the parameter handling module 340. The OLAP processor 350 is intended to select data from a data source 360, using the list of non-ordered UUIDs. The OLAP processor cannot process data such as the user entry as a range of ordered IDs but needs UUIDs. In one embodiment, the data source 360 is transactional MDAV.

In one embodiment, the system 300 includes a filtering module (not shown) to filter the selected data by the OLAP processor 350. The selected data is reduced based on the used filter. For example, the selected data is reduced to fit into an exact time period.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

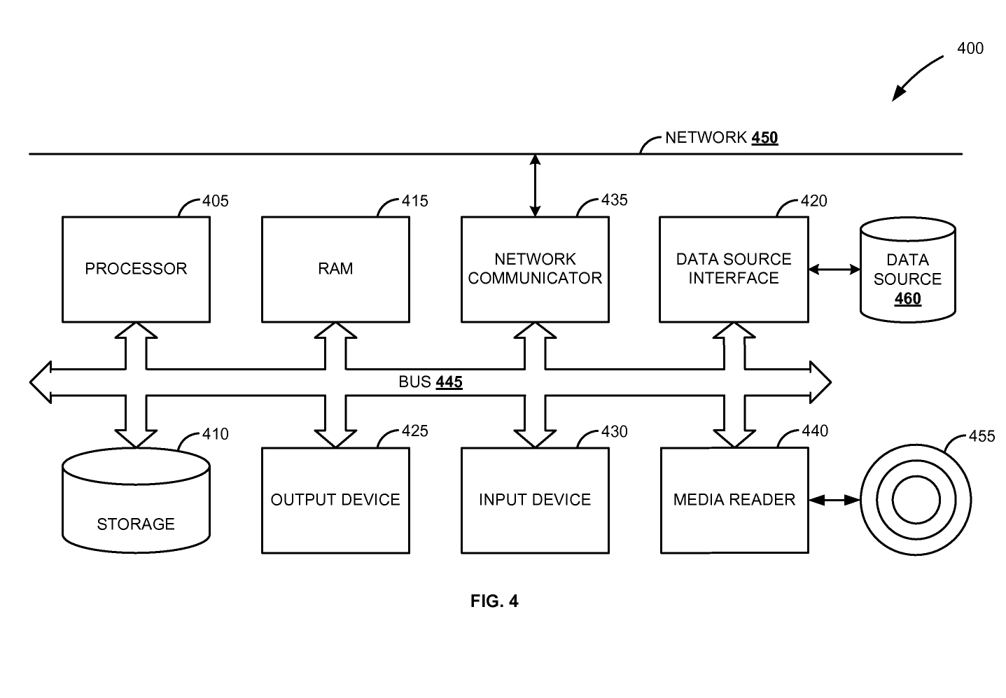

FIG. 4 is a block diagram of an exemplary computer system 400. The computer system 400 includes a processor 405 that executes software instructions or code stored on a computer readable storage medium 455 to perform the above-illustrated methods of the invention. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment of the invention, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method comprising:
receiving a user entry of one or more identifiers (IDs) as a range of ordered values for querying data and generation of analytical result, the one or more IDs being external representation of one or more universally unique identifiers (UUIDs);
analyzing the one or more IDs to extract a list of non-ordered UUIDs, the list of non-ordered UUIDs being internal representation of the one or more IDs;
passing the extracted list of non-ordered UUIDs to an Online Analytical Processing (OLAP) processor; and
selecting data, through the OLAP processor, using the list of non-ordered UUIDs for the generation of the analytical result.

2. The method of claim 1, wherein the IDs are human readable IDs.

3. The method of claim 1, wherein the one or more UUIDs are used as keys of business object instances.

4. The method of claim 1, wherein the one or more UUIDs are used to model references between business model instances.

5. The method of claim 1, wherein analyzing the one or more IDs to extract the list of non-ordered UUIDs further comprises pre-querying a master data Multidimensional View (MDAV), the master data MDAV maintaining ID-UUID mapping.

6. The method of claim 1, further comprising filtering the data selected through the OLAP processor using a predefined filter.

7. The method of claim 1, wherein selecting, through the OLAP processor, data using the list of non-ordered UUIDs further comprises selecting the data from a transactional MDAV.

8. A computer system including at least one processor for executing program code and memory, the system comprising:
a user interface to receive a user entry of one or more identifiers (IDs) as a range of ordered values for querying data and generation of analytical result, the one or more IDs being external representation of one or more universally unique identifiers (UUIDs);
a parameter handling module to analyze the one or more IDs and to extract a list of non-ordered UUIDs, the list of non-ordered UUIDs being internal representation of the one or more IDs; and
an OLAP processor to select data from a data source using the list of non-ordered UUIDs for the generation of the analytical result.

9. The system of claim 8 wherein the IDs are human readable IDs.

10. The system of claim 8, wherein the one or more UUIDs are used as keys of business object instances.

11. The system of claim 8, wherein the one or more UUIDs are used to model references between business model instances.

12. The system of claim 8, wherein the parameter handling module is further operable to pre-query a master data Multidimensional View (MDAV), the master data MDAV maintaining ID-UUID mapping.

13. The system of claim 8, further comprising a filtering module to filter the data selected through the OLAP processor.

14. An article of manufacture including a non-transitory computer readable storage medium to tangibly store instructions, which when executed by a computer, cause the computer to:
receive a user entry of one or more identifiers (IDs) as a range of ordered values for querying data and generation of analytical result, the one or more IDs being external representation of one or more universally unique identifiers (UUIDs);
analyze the one or more IDs to extract a list of non-ordered UUIDs, the list of non-ordered UUIDs being internal representation of the one or more IDs;
pass the extracted list of non-ordered UUIDs to an Online Analytical Processing (OLAP) processor; and
select data, through the OLAP processor, using the list of non-ordered UUIDs for the generation of the analytical result.

15. The article of manufacture of claim 14, wherein the IDs are human readable IDs

16. The article of manufacture of claim 14, wherein the one or more UUIDs are used as keys of business object instances.

17. The article of manufacture of claim 14, wherein the one or more UUIDs are used to model references between business model instances.

18. The article of manufacture of claim 14, wherein the instructions to analyze the one or more IDs to extract the list of non-ordered UUIDs further comprise instructions to pre-query a master data Multidimensional View (MDAV), the master data MDAV maintaining ID-UUID mapping.

19. The article of manufacture of claim 14, further comprising instructions, which when executed by a computer, cause the computer to filter the data selected through the OLAP processor using a predefined filter.

20. The article of manufacture of claim 14, wherein the instructions to select, through the OLAP processor, data using the list of non-ordered UUIDs further comprise instructions to select the data from a transactional MDAV.
